(19) United States
(12) Patent Application Publication
(10) Pub. No.: US 2025/0376202 A1
(43) Pub. Date: Dec. 11, 2025

(54) FOLDING TRAY CART WITH SAFETY DEVICE AND METHOD

(71) Applicant: Judy Chen, Henderson, NV (US)

(72) Inventor: Judy Chen, Henderson, NV (US)

(21) Appl. No.: 19/232,800

(22) Filed: Jun. 9, 2025

Related U.S. Application Data
(60) Provisional application No. 63/657,972, filed on Jun. 9, 2024.

(51) Int. Cl. B62B 3/02; A47B 31/00; A47B 31/04

(52) U.S. Cl. CPC B62B 3/02; A47B 2031/002; A47B 31/04; B62B 2205/02; B62B 2205/20; B62B 2501/065

(57) ABSTRACT

A folding tray cart and method for same, the folding tray cart comprises a collapsible framework pivotally supporting one or more sets of split shelves, each split shelf comprises a pair of half shelves, the folding tray cart moves between an first open operating position with the respective sets of split shelves being held in spaced-apart, stacked, horizontal orientation within the collapsible framework and a second closed, vertical orientation where the collapsible framework is collapsed in manner that places each half shelf pair into an inverted “V” shape configuration; wherein inner edges of the half shelf pairs are made from soft resilient compressible material so that if a portion of a cart operator's body is caught between a closing gap formed between the inner edges, the inner edges will temporarily deform in a manner to prevent injury to the portion.

### STATEMENT REGARDING FEDERALLY SPONSORED RESEARCH OR DEVELOPMENT

Not Applicable.

### REFERENCE TO A “MICROFICHE APPENDIX”

Not Applicable.

### FIELD OF THE INVENTION

The present invention may relate to wheeled or non-wheeled folding tray carts whose shelving could be moved from a compacted vertical storage position to an open horizontal operating position for holding, transporting or both, of goods. More particularly, to those folding non-wheeled or wheeled tray carts that may further embodied one or more safety devices to generally prevent pinching or crushing injuries due to the folding and unfolding of nature of the folding tray cart operations.

### BACKGROUND

Wheeled and non-wheeled folding tray carts may be generally used in a wide variety of industries, including but not limited to the food service and preparation industries, to hold, transport or both a wide variety of goods. In periods of non-use, wheeled and non-wheeled folding tray carts may be placed in a folded or otherwise compacted state providing a smaller footprint for storage.

The folding tray cart may comprise a collapsible framework pivotally holding a set of split shelves with each split-shelf further comprising a pair of half-shelves. The collapsible framework may be made of suitable material (e.g., plastic, metal, etc.) and, in one embodiment, may be mounted on a set of wheels (e.g., castor wheels). In another embodiment, the collapsible framework may lack the set of wheels and stand directly upon a ground or supporting surface to present the folding tray cart.

The folding tray cart may move between a first, compacted, storage position to the second, open, operative position. Placing the folding tray cart into the first compacted, storage position could move portions or sections of the collapsible framework closer together. This closing action may further move split-shelves' center sections (e.g., inner edges of the respective half-shelves) upward to generally locate the half-shelves into vertical orientations.) The split-shelves generally fold together like inverted butterfly wings (e.g., an upside down “V) and opening gaps between the respective half-shelves' inner edges.

The folding tray cart, when subsequently moving into the second, open, operative position may position the folding tray cart's collapsible framework sections further apart from each other so that the split-shelves unfold and to have each half-shelf pair generally adopt the horizontal position or orientation (e.g., lie flat.)

One possible issue with the folding tray cart (especially the wheeled version) could be that closing gaps may open up between the inner edges of a half shelf pair as the half shelf pair moves from the second, open, operative position to the first, compacted, storage position. As these gaps close when the folding tray cart moves from the first, compacted, storage position to second, open, operative position (e.g., the half shelf pair moves from vertical to horizontal orientation) the cart operator may put their hand(s) on the (e.g., top) half shelf pair to further push down on the half shelf pair to aid in moving the half shelf pairs from vertical storage position to horizontal operating position. During the said cart opening movement, the closing gap(s) may close upon a portion(s) of the operator's hand(s) potentially causing pinch or crush injuries.

### SUMMARY OF ONE EMBODIMENT OF THE INVENTION

Advantages of one or more embodiments of the present invention.

The various embodiments of the present invention may, but do not necessarily, achieve one or more of the following advantages:
to provide a folding tray cart that moves between an operating and storage positions with a means to avoid the pinching of the operator's bodily parts by gaps defined the shelving of the folding tray cart;
the ability to using pivoting connection points between the shelving halves and the collapsible framework that may slow the transition of movement of the folding tray cart between an operating and storage positions to allow the operator to timely remove fingers/hands from potential crush areas of the folding tray car during said movement;
to provide a folding tray cart that imparts friction force to slow the transition of movement of the folding tray cart between an operating and storage positions;
the ability to give greater control to the operator over the opening of a folding tray cart to prevent pinch or crushing injuries;
to provide folding tray cart with fastener-combinations to pivotally connect spit-shelving to collapsible framework with washers sandwiched between the collapsible framework and the half-shelve pairs that further dampen or retard the movement of folding tray cart from storage to operating positions;
the ability dampen or retard the opening movement of split-shelves of folding tray cart through the use of fastener-resilient or elastic washer combinations as pivoting connectors between the framework and the shelving halves as the folding tray cart moves from storage to operating positions;
the ability to require greater operator interaction and attention to move the folding tray rack from compact storage to open operational positions;
to provide deformable safety inner edges for half-shelf pairs of a folding tray cart to generally ameliorate the possible occurrence of operator crushing injuries; and
the ability to employ vertical springs with collapsible framework's vertical spar that may slow down the movement of the shelving halves as folding tray cart move from a closed vertical position to an opening operating position.

These and other advantages may be realized by reference to the remaining portions of the specification, claims, and abstract.

### BRIEF DESCRIPTION OF ONE EMBODIMENT OF THE PRESENT INVENTION

The present invention may present various solutions used separately or in various combinations with each other to substantially reduce the probability of occurrence of crush or pinch injuries during cart operations. One possible injury amelioration solution may utilize fastener combinations that movably connect shelving to the cart framework, the fastener combinations may further provide pressure or compression upon said movably joined cart parts to generally slow down the movement of the cart shelving from a closed, vertical compact storage position to an open, horizontal, operating position. Another possible injury amelioration solution could have inner shelving edges may be made of soft resilient material that would be compressed or deformed around a portion of the operator's body that could protrude within the gap that could form between half shelving pairs. Yet another possible injury amelioration solution could employ a vertically oriented spring bias that may be integrated into the collapsible framework that is movably connected to cart shelving to otherwise slow down the opening motion of the folding tray cart to generally prevent operator pinch or crush injuries.

One possible embodiment of the invention could be a folding tray cart whose collapsible framework and split-shelving mat be made of hard, noncompressible material, the folding tray cart further comprising a collapsible framework that moveably supports a set of split-shelving with at least one fastener and non-compressible washer combination that pivoting connects at least one split-shelving to the collapsible framework, the at least one fastener and non-compressible washer combination compresses the said non-compressible washer as sandwiched between the collapsible framework, and a split-shelving, wherein the compressible framework and split shelving pressures upon the non-compressible washer imparts a frictional force to the split shelving, collapsible framework or both to slow or otherwise retard the movement of the folding tray cart between a first compacted storage position and a second open operating position.

Another possible embodiment of the invention could be a folding tray cart made from soft deformable materials and further comprising a collapsible framework that moveably supports a set of split-shelving with at least one fastener and resilient washer combination that pivoting connects at least one split-shelving to the collapsible framework, the at least one fastener and resilient washer combination further comprises a fastener pivotally supporting and compressing at least one resilient washer, collapsible framework, a split-shelving together, wherein the said compression imparts a frictional force to the split shelving, collapsible framework or both to slow or otherwise retard the movement of the folding tray cart between a first compacted storage position and a second open operating position.

Yet another possible embodiment of the invention could be a folding tray cart made from lightweight materials and comprising a collapsible framework pivotally supporting one or more sets of split shelves attached to the collapsible framework by a set of fastener combinations. The folding tray cart could move from a first open operating position wherein the set of split shelves could be held in spaced-apart, stacked, horizontal orientation within the collapsible framework and a closed storage position. The collapsible framework may then be compacted to a second closed compacted storage position wherein each half shelf pair may be placed into an accordion-like, inverted “V”-shaped or accordion like configuration, wherein the respective fastener combinations may be applied to movably connect the collapsible framework and pairs of half shelf together so that roughen surfaces of the framework and split shelves can interact with each other under compression pressure to frictionally slow down the movement of the said split shelves between a first closed storage position and a second open operating position.

Still yet another possible embodiment of the invention could be a folding tray cart comprising a collapsible framework pivotally supporting one or more sets of split shelves may be movably attached to the collapsible framework, each split shelf further comprises a pair of half shelves, the folding tray cart moves between an first open operating position wherein the set of split shelves could be held in spaced-apart, stacked, horizontal orientation within the collapsible framework and a closed storage position wherein the collapsible framework may be collapsed in manner to move each half shelf pair into an accordion-like, inverted “V”-shaped or accordion like configuration, wherein the inner edges of the half shelf pairs could be made from soft resilient compression material so that if any the portion of the cart operator's body may be caught with between a closing gap formed between the inner edges, the inner edges will temporarily deform in a manner to prevent injury to the portion.

Further, still yet another possible embodiment of the invention could be a folding tray cart comprising a collapsible framework pivotally supporting one or more sets of split shelves may be movably attached to the collapsible framework, each split shelf further comprises a pair of half shelves, the folding tray cart moves between an first open operating position wherein the set of split shelves may be held in spaced-apart, stacked, horizontal orientation within the collapsible framework and a second closed storage position wherein the collapsible framework may be collapsed in manner to move each half shelf pair into an accordion-like, inverted “V”-shaped or accordion like configuration, wherein the inner edges of the half shelf pairs on each side of the respective half shelf pair could be movably connected to respective inner vertical spar, each inner vertical spar having vertical spring bias to slow down the movement respective inner vertical spar and the split shelves as the half shelves complete the movement from a closed storage position to open operating horizontal position.

Further yet still another possible embodiment of the invention could be a method of operating a folding tray cart, comprising the following steps providing a folding tray cart comprising a collapsible framework pivotally supporting a set of split shelves, each split shelf comprises a pair of half shelves to allow the folding tray cart to move between an open operating position wherein the set of split shelves may be held in spaced-apart, stacked, horizontal orientation within the collapsible framework and a compacted storage position wherein the collapsible framework may be collapsed in manner to move each half shelf pair into an accordion-like, inverted “V”-shaped configuration, wherein each half shelf may be movably attached to the respective framework by a respective fastener-resilient washer combination that individually comprises a fastener that movably compresses a respective washer to impart a fictional force to half shelf, framework or both in a manner that slows the movement of the collapsible framework and split shelving between a closed storage position and an open operating position; moving the folding tray cart between a closed storage position to an open operating position; and resisting the moving the folding tray cart between a closed storage position to an open operating position.

The above description sets forth, rather broadly, a summary of one embodiment of the present invention so that the detailed description that follows may be better understood and contributions of the present invention to the art may be better appreciated. Some of the embodiments of the present invention may not include all the features or characteristics listed in the above summary. There may be, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein could be for the purpose of description and should not be regarded as limiting.

### BRIEF DESCRIPTION OF THE DRAWINGS

FIG. 1 is substantially a perspective end view of one embodiment of a folding tray cart in the open or operating position.

FIG. 2 is substantially a perspective end view of one embodiment of a folding tray cart in the folded or storage position.

FIG. 3 is substantially a perspective exploded view of the present invention using a fastener combination with washer, showing one washer being used to pivotally connect a half-shelving to the collapsible framework.

FIG. 4 is substantially a perspective exploded view of the present invention using a fastener combination with washer, showing multiple washers being used, pivotally connecting a one portion of the collapsible framework to another portion of the collapsible framework.

FIG. 5 is substantially a perspective view of the present invention using safety inner edges on the half shelf pairs.

FIG. 6 is substantially a perspective view of the present invention using spring-biased inner vertical spars.

FIG. 7 is substantially a schematic flowchart showing one possible embodiment of a process or method for operating the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

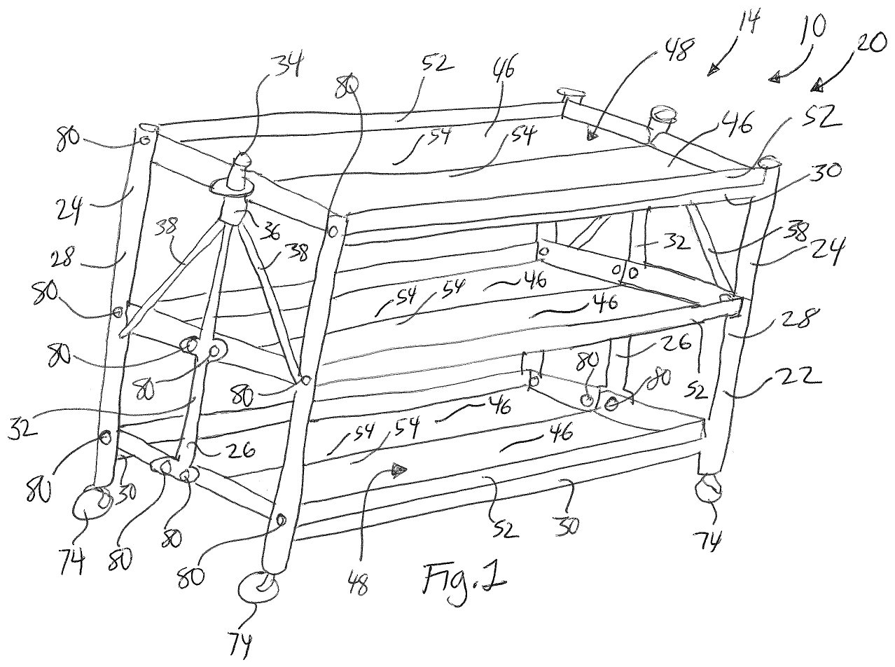

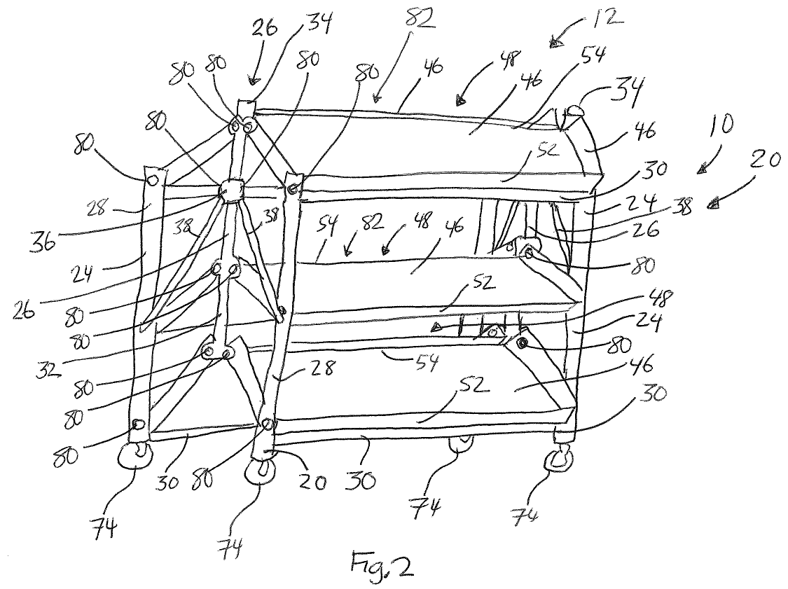

As substantially shown in FIGS. 1 and 2, the present invention 10 in one possible embodiment could comprise a folding tray cart 20 utilizing one or more fastener combinations 80 to pivotally connect the split-shelving set 48 (e.g., a set of half-shelving pairs 46) to the collapsible framework 22 and method for operating same 200. The folding tray cart 20 could further utilize one or more fastener-combinations 80 to pivotally connect one portion of the collapsible framework 22 to a portion of the split-shelving set 48; one portion of the collapsible framework 22 to another portion of the collapsible framework 22 or the like. The invention 10 could be applied to both wheeled and wheelless versions of the folding tray cart 20.

The folding tray cart 20 may comprise a collapsible framework 22 that may stand on a set of castor wheels 74 or the like, the collapsible framework 22 further foldably supporting a set of split-shelves 46. The collapsible framework 22 could collapse together to lift and fold the set of split shelves 64 vertically, into an inverted V-shape (e.g., to generally place each of the pairs of half-shelves into vertical orientations) to substantially allow the folding tray cart 20 to be placed in a closed or collapsed/compacted storage condition 12. The collapsible framework 22 could likewise be pulled apart to lower and unfold split shelves 46 (to place each of the half-shelf pairs into horizontal orientations) to place the folding tray cart 20 in unfolded operating condition 14.

The collapsible framework 22 could comprise a vertically oriented inner framework section 26 that is generally located between two vertically oriented outer framework sections 24, these three framework sections may be movably held in a parallel relationship to one and other. Each outer framework section 24 could be a rectangular-shaped and generally comprise two parallel and spaced-apart vertical spars 28 connecting two spaced-apart and parallel horizontal spars 30. Additional horizontal spars 30 could be located between the first two horizontal spars 30 further connecting to the vertical spars 28 for additional framework structural support. Each additional horizontal spar 30 could generally match up with an outer edge 52 of a respective additional half-shelf 48 located between the top and bottom split shelving 46.

Each outer framework section 24 could be located along one side of the folding tray cart 20 along a set of outer edges 52 as presented by a set of split shelves 46. The outer framework sections 24 could be pivotally connected to the corners of the set of split shelves 46 by set of fastener-combinations 80.

The inner framework section 26 could comprise two inner vertical spars 32 with each inner vertical spar 32 being pivotally connected by fastener-combinations 80 with a respective end of folding tray cart 20. A respective inner vertical spar 32 could be pivotally connected by fastener-combinations 80 to the half-shelving pair together approximate to their respective inner edges 54. In one possible embodiment, at least one inner vertical spar 32 could further comprise a handle 34 (e.g., substantially located at the top of inner vertical spar 32) that may allow for operator movement of the vertical inner spar 32 (generally to move the folding tray cart 20 between an open or unfolded operating position 14 to folded or collapsed storage position 12.) The handle 34 could also be configured to further act as a locking device to hold the folding tray cart 20 in either an open or unfolded operating position 14, the collapsed storage position 12 or both.

One possible embodiment of inner vertical spar 32 be movably connected to slider 36 that may be further pivotally connects to the ends of two support struts 38. The other ends of the support struts 38 may be splayed outward to pivotally connect to the respective vertical spars 28 of the outer frame sections 24 on one end of the folding tray cart 20. In this manner, as the outer framework sections 24 moves into or out of the folded or collapsed storage position 12, the support struts 38 may allow slider 36 to move along a length of the inner vertical spar 32 (e.g., or may be seen as generally allow the inner vertical spar 36 to move though the slider 36) via the folding and unfolding action of split-shelves 46. This slider 36 action may help the folding tray cart 20 transition smoothly between open operating and collapsed storage positions 14, 12. The slider 36 may further removably connect to the bottom of the handle 34 (e.g., locking device) to help hold the folding tray cart 20 in the unfolded or open operating position 14 until locking device 34 could be activated to release the slider 36 and allow the wheeled tray cart 20 to be moved into the collapsed storage position 12.

The collapsible framework 22 may pivotably hold a set of split-shelves 46 in a generally horizontal, parallel and spaced-apart when placed in the open operating position 14. Each split-shelf 46 can be separated or split along split-shelf's longitudinal centerline to form at least a half-shelve pair 48 that may be held together in a pivotal relationship by the collapsible framework 22. The collapsible framework 22 may pivotally hold each split-shelf 24 in a manner that allows the center of each split-shelf 46 (e.g., generally demarcating where a respective split-shelf's half-shelve pair 48 substantially meet) and the inner framework 26 to move upward allowing the corresponding half shelve pairs 26 to generally fold together like inverted butterfly wings or in an accordion fashion (e.g., substantially like an upside down “V”.) This closing action substantially moves the outer frame sections 24 closer to one another and closer to the inner frame section 26 that may be moved upward to substantially form a collapsed storage position 12. In the generally compacted, vertically oriented, storage position 12, the center sections of the split shelves 46 and the inner edges 54 of the half shelves 48 may be substantially raised up so that the outer edges 52 of half shelves 48 (e.g., split shelf 46) may be brought closer together.

In moving towards the open, generally horizontally oriented, operative position 14, the center of the split shelf 46 may drop down, generally moving the outer framework sections 24 further apart from each other; lowering the inner framework section 26; substantially placing the respective half shelves 48 of a respective split shelf 46 flat in the same horizontal plane; and locating each split shelf 46 in spaced-apart and parallel relationship to one another. During this movement, a closing gap 82 may be initially formed between the opposing half-shelves 46 of the split-shelf 46 (e.g., the top split-shelf 46) when folding tray cart 20 is substantially in the collapsed storage position 12. This closing gap 82 may provide an opportunity for a crush or pinch injury to occur to a portion of the operator's body (not shown), namely, the operator's fingers/hands that may unwitting be placed within the closing gap 82 as the operator generally pushes down upon the top split shelf 20 to move the folding tray cart from the closed, generally vertically oriented, collapsed/compacted storage position 12 into the open, generally horizontally oriented, operating position 14. As the opposing half-shelves 46 of top split-shelf 46 may be moved from a collapsed storage position 12 to open operating position 14, the closing gap 82 may be reduced in size providing the ability to provide said pinch or crush injury to the operator with significant force.

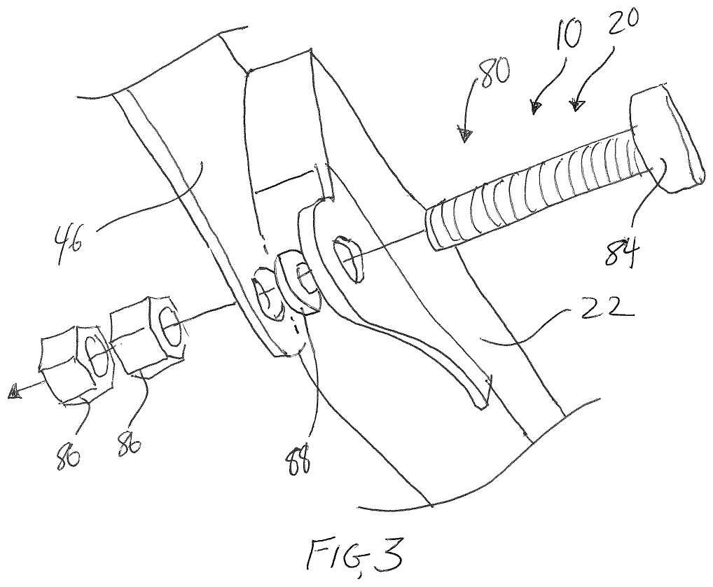

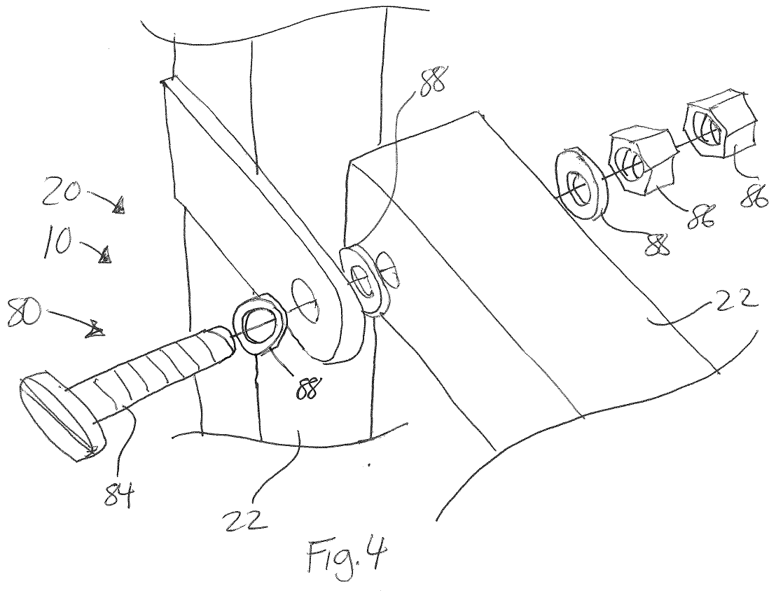

As substantially shown in FIGS. 3 and 4, one possible means to ameliorate the likelihood of occurrence of such “snap-down” pinch or crush injuries could be implemented by a capability to slow down the transition of the folding tray cart 20 moving between the collapsed/compacted storage position 12 and the open operative position 14. The invention 10, as such, could further comprise a fastener combination 80 that may be used to provide pivoting connections between half-shelves 46 and collapsible framework 20 and the like. The fastener combination 80 could comprise a permanent fastener 90 that may be permanently attached in nature (e.g., a rivet) or a fastener 90 that may be temporarily attached in nature (e.g., a bolt/screw 84 with nut[s] 86.) The fastener combination 80 may further incorporate one or more washers 88. The present invention 10 may use different types of washers 88 depending on the materials used to make the folding tray cart 20. If compressible framework 22/split shelving 48 may be made from hard, noncompressible material (e.g., a hard metal like steel) then a hard, noncompressible washer (e.g., made of hard metal such as steel) may then be used in the fastener combination 80. If collapsible framework 22 comprises soft materials, such as polymers such as plastic or the like then the resilient yet compressible washers 88 (made from resin, plastic or other polymers) may be used in the fastener combinations 80.

In another version of the invention 10, the folding tray cart framework 22, split-shelving set 48 both could be constructed out of lightweight materials (e.g., plastic, carbon fiber, or lightweight metals such aluminum) then the fastener combination 80 may dispense with the use of a washer(s) and instead have the slit shelves 48 and the framework 22 be constructed with rough surfaces or have a rough finish (NOT SHOWN) applied to appropriate surfaces of the respective collapsible framework 22 and split-shelving 48/half-shelving pair 46 portions that pivotally contact each other. The subsequent compressed moving interaction of the split-shelving 48/half-shelving pair 46 portions to the framework portions, the relevant portions being held together in tensioned pivotal connection by appropriate fastener combination 80, the relevant portions' rough surface or applied rough finish (not shown) or the like that may create or increase a frictional resistance to folding tray cart's opening movement so as to slow said opening movement.

One embodiment of the invention 10 could have a fastener combination 80 that may employ a one or more washers 88 with a fastener 90. The fastener combination 80 could movably connect portions of the collapsible framework 22 and half-shelf 46 together [or alternatively movably connect just portions of the collapsible framework 22 together) in a manner that substantially supports one washer 88. The fastener combination could hold the washer 88 so that the washer 88 could be sandwiched in between a portion of the collapsible framework 22 and a portion of a split-shelve 48 or be sandwiched between a head of the fastener 90 and a portion of the collapsible framework 22/split shelf 48 or be sandwiched between the face of nut 86 attached to the fastener 90 and a portion of the collapsible framework 22/split shelve 48.

The fastener combination 80 could further comprise a fastener 90 (e.g., screw 84/bolt) and washer 88 that may be secured and tensioned in place by one or more nuts 86 to movably connected together portions of collapsible framework 22 and split shelf 48 and the like.

In one version of the invention 10, the fastener combination 90 may use a nut pair 86 (e.g., substantially comprising metal nuts), a first nut 86 may be tightened down along the threaded length of the fastener 90 to set the desired amount compression or tensional pressure upon the washer 86. The second nut 86 may be applied along the threaded length of the fastener 90 as well to be tightened down against the first nut 86 to lock or otherwise hold the first nut 86 in a desired position on the fastener 90. The force of compression that may be created upon the resilient washer(s) 88 could cause a frictional force that generally slows down the pivotal movement of the first collapsible framework portion 22 relative to the half-shelf 46/second collapsible framework portion 22 to generally slow the movement of the folding tray cart 20 form a closed compacted position to an open operating position.

Alternatively, a single metal locking nut may be used instead of the nut pair. The metal locking nut may slightly deform the fastener threads to securely retain the metal locking nut in place upon the fastener 90.

Alternatively, the invention 10 may also use plastic (e.g., nylon) or nylon insert based locking nuts as well. The plastic thread portion of such nuts 86 may become distorted when engaging the fastener's threads to substantially provide the nut's locking ability. These types of locking nuts may have locking ability in that their respective plastic portions may lose their locking ability through repeated vibrations/motions imparted by cart operation or by high operational environmental temperatures and the like.

Another version of the invention 10 may use a fastener-combination 80 having multiple washers 88. The fastener-combination 80 may have a fastener 90 (e.g., a screw 84/bolt) substantially movably pass through a portion of the collapsible framework 22, then through a half shelf 46 (or alternatively another portion of the collapsible framework 22). The fastener 90 may generally be secured by nut(s) 86 as described above. The fastener 90 may hold a first washer sandwiched between the portions of the compressible framework and the split shelving and the like. Additionally, or alternatively, a second washer could be generally sandwiched between the head of the fastener 90 that connected collapsible framework portion/split-shelving portions to generally prevent the fastener head from contacting the connected collapsible framework portion/split-shelving portions. Additionally, or alternatively, a third washer could be generally sandwiched between the base of the nut that secures the fastener 90, which substantially connects the collapsible framework portion/split-shelving portion together to generally prevent the nut base from contacting the connected collapsible framework/split-shelving portions.

This fastener combination 80 using multiple washers 88 could slow the tray's opening-closing process by tighten down the fastener-combination 80 to apply compression or torsional pressure to the washers creating a frictional resistance or bias against the opening movement of the folding to slow the opening movement of the folding tray cart 20. Slowing the folding tray cart's opening process could give the operator more time to notice and remove any hand or other body portions from the half-shelving's closing gap 82 (e.g., moving the operator's hands/fingers out of being between the half shelves' inner edges 54) to prevent possible crushing or pinching injuries.

Yet another version of invention (not shown), could be used with folding tray cart 20 having a collapsible framework/spit-shelving set made from a soft material such as polymer such as plastic and use fastener combinations that do not include washer(s). This version of the invention could generally use a rough surface 94 on or have a rough finish as applied to the portions of collapsible framework 22/split shelving 48 that could be movably held together by a fastener combination 80. The created frictional interface could slow a rotational movement of the portions of collapsible framework 22/split shelving 48 that may be movably held together by a fastener combination 80. In this manner, this embodiment can be seen to act as a safety device in slowing down the opening motion of the folding tray cart 20 to generally give the operator time to notice that a portion of the operator's body (not shown) that may be held by a closing gap 82. The operator by acquiring this situational awareness could remove that said portion from the closing gap 82 before a pinch or crushing injury could occur to said portion.

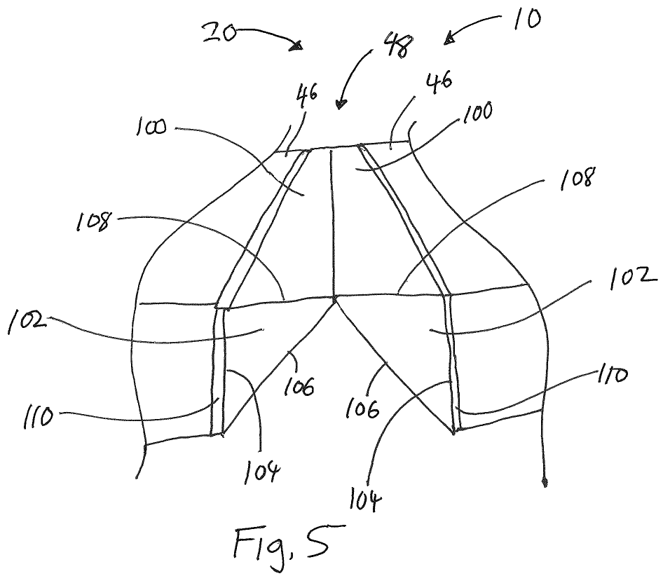

As substantially shown in FIG. 5, yet another embodiment of the invention 10 could feature another possible safety embodiment, wherein the inner edges 54 of the half shelf pair 48 constituting a split shelf 46 generally be safety edges 100 or pressure sensitive devices. The inner edges 54 could comprise compressible, resilient material so that if a portion of the operator's hand or other part of the operator's body (not shown) could be caught within a closing gap 82, as formed between the inner edges 54, as the closing gap 82 may be closing during cart operations, the inner edges 54 will then deform around the portion of the operator's hand to prevent the half-shelf pair 48 from pinching or crushing the portion of the operator's hand (not shown).

In one version of the embodiment, the compressible resilient material could be a polymer that might include rubber, flexible polyurethane foam, plastic or other similar material. The inner edge 54 could be a safety strip 102 of said suitable soft, compressible, resilient material wherein the lateral cross section of the said safety strip 102 could be a right triangle denoting three sides of the safety strip 102: the hypotenuse or underside 104, opposite or attaching or side 106 and adjacent or top side 108. The attaching side 106 could be abutting and attached to the respective half shelf 46. The adjacent side 108 could be otherwise continuous to the top of the respective half shelf 46. The attaching side 104 could further comprise a double-sided adhesive strip 110 that could hold inner edge 54 in place to the respective half shelf 46. When the half shelf pair 46 may be placed in a horizontal position during cart operations the outward edges 112 of the applied safety strips 102 could be adjacent to one another. The angled surface of the underside 104 could generally ensure that a minimal amount of the safety edges 100 would come into initial contact with the portion of the operator's hand (not shown) if caught in the closing gap 82. That minimal amount of safety edges 100 should then easily deform around the portion of the operator's hand (not shown) to prevent injury to same. At the same time, enough material of the safety edges 100 could be presented to generally support any materials being carried by the respective split shelf 48 and prevent the said materials from falling through the closed gap 82.

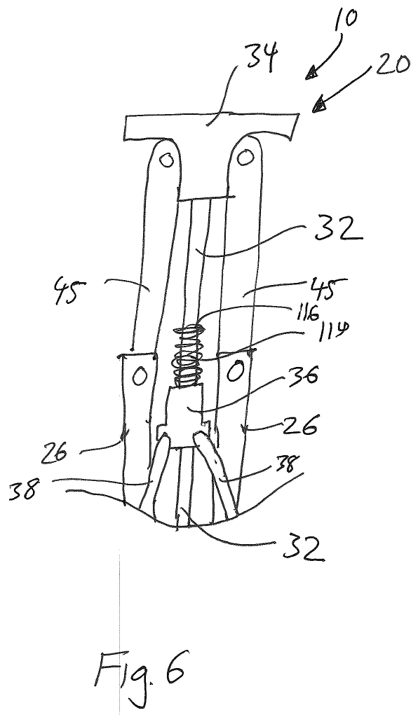

As substantially shown in FIG. 6, still yet another embodiment of the invention 10 could be folding tray cart with an opening safety device generally comprising a spring, namely a compression cylindrical coil spring 114, namely, a coil spring with spaces between the spaced-apart coils as arranged in a cylindrical configuration, that could be movably applied to respective inner vertical spar 32. In this manner, a portion of the inner vertical spar 32 could movably pass through the hollow spring interior 116 as defined by the compression cylindrical coil spring 114. The compression cylindrical coil spring 114 could be movably held captive on a respective inner vertical spar 32 and be located between the bottom of the handle 34 and the top of the slider 36. The handle 34 could be fixed attached to a top end of the inner vertical spar 32 while the bottom end of the inner vertical spar 32 end could movably pass through the slider 36. As the inner vertical spar 32 may movably pass down through the slider 36 (e.g., though a downward operator pressure applied to the handle 34), the inner vertical spar 32 substantially moves the split shelves 48/half-shelves 46 from vertical collapsed storage position 12 to horizontal open operating position 14. Conversely, moving the inner vertical spar 32 upward through the slider 36 (e.g., though upward pressure applied to the handle 34), the inner vertical spar 32 substantially moves the split shelves 48 from horizontal operating positions 14 to vertical storage positions 12.

When the inner vertical spar 32 could be located in an up position (e.g., placing the split-shelve set 48/half shelve pairs 46 in the vertical collapsed storage position 12) the bottom of the compression cylindrical coil spring 114 may rest on the top of the slider 36 but the top of the compression cylindrical coil spring generally is not in contact with the bottom of the handle 34. As the inner vertical spar 32 moves downward through the slider 36, the handle bottom may come into comes into contact with the top of the compression cylindrical coil spring 114. As the inner vertical spar 32 continues the downward movement through the slider 36, the handle 34 may compress compression cylindrical coil spring 114 to impart an upward spring bias to the inner vertical spar 32. This upward spring bias could slow the downward movement of the inner vertical spar 32 as inner vertical spar 32 brings the split-shelve set 48/half-shelve pairs into their respective horizontal operating positions 14 as the gaps 82 between the respective half-shelf pairs 46 may be closing (this especially important with the top half-shelf pair 46 where pinching injuries could occur in the respective closing gap 82 as the top half-shelf pair 46 reaches the respective optimal horizontal open operating position 14.

The slowing of the movement of the half-shelf pairs 46 to their respective horizontal open operating positions 14 may allow the operator (not shown) of the folding tray cart 20 to visually observe, tactically notice or otherwise become aware of a situation wherein a portion of the operator's hand or other parts of the operator's body may be in danger of being pinched by a respective closing gap 82. This operator situational awareness may be provided by an opposing spring bias set forth by the compressing the general vertically oriented, compression cylindrical coil spring 114 during the opening operation of the folding tray cart 20 that may help the operator with a timely removal of a portion of operator's body (not shown) that may otherwise be pinched or crushed by the gap 82.

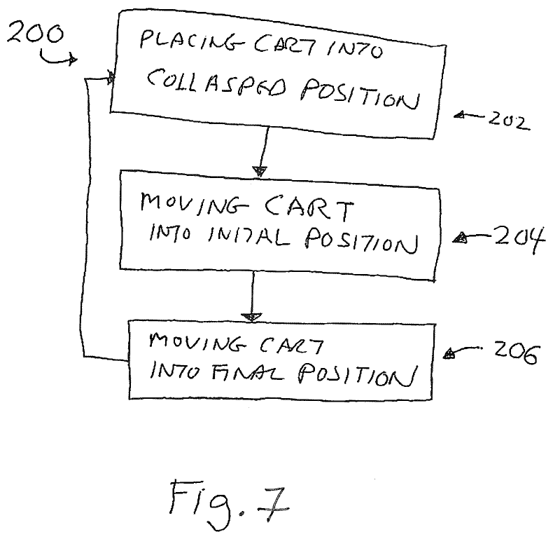

As substantially shown in FIG. 7, one possible embodiment of a method or process 200 of operating the invention 20 could commence with step 202, placing folding tray cart into the collapsed storage state. Locking devices (e.g., as formed by the vertical inner spar handle), if any, could then be accessed, released and be used to pull the inner framework's inner vertical spars upward. This action could move the inner edges of the half shelving upward and apart from another forming a gap; move the individual split shelfing towards an inverted folded butterfly or inverted “V” configuration and move the two outer support frames towards one another and the inner framework. The folding tray cart could be held in the collapsed (or folded/compacted) storage position or configuration by the handle/locking device(s) or the like. At the close of this step, the process 200 could proceed to step 204, moving the folding tray cart into initial opening position.

In step 204, moving the folding tray cart into initial opening position, the operator could unlock any locking devices holding the folding tray cart in the folded storage position. The weight of the split shelving could help move inner vertical spars downward; generally move the outer framework sections out and apart from one another and the inner framework; substantially move shelving halves of respective split shelves down away from the inverted “V” configuration towards a horizontal orientation.

In one version of the invention, wherein the framework and split-shelving set may be made from soft materials such as polymers like plastic, the fastener combinations can further utilize resilient washer(s) (e.g., made from nylon, paper or the like) to movably connect portions of the collapsible framework with split-shelving set. The fastener combinations with resilient washer(s) can compress the resilient washer(s) with the said portions to create a frictional interface that may significantly slow down the opening movement of the folding tray cart.

In another version of the invention, wherein the framework and split-shelving set may be made from hard materials such as metal like steel, the fastener combinations can further utilize hard washer(s) (e.g., made from metal like steel or the like) to movably connect portions of the collapsible framework with split-shelving set. The fastener combinations with hard washer(s) can compress the hard washer(s) with the said portions to create a frictional interface that may significantly slow down the opening movement of the folding tray cart.

In yet another version of the invention, wherein the framework and split-shelving set may be made from harder yet lightweight material such as aluminum and the like, the fastener combinations so used may dispense with the washers and instead may have the rotatably connected portions of the collapse framework and split shelving have rough surfaces or rough finishes applied appropriate portions of their surfaces. As the rough finishes/rough surfaces movably interact with each other, the result may create a frictional interface that may significantly slow down the opening motion of the folding tray cart.

In still yet one other version of the invention, a compression cylindrical coil spring 114, could be movably vertically applied and be captively held to a respective inner vertical spar 32. In this manner, a portion of the inner vertical spar 32 could movably pass through the hollow spring interior 116 as defined by the compression cylindrical coil spring 114. As the inner vertical spar 32 moves the downward movement through a slider 36, the handle 34 may compress the compression cylindrical coil spring 114 to impart an upward spring bias to the inner vertical spar 32 that may significantly slow the opening movement of the folding tray cart.

In yet still another version of the invention, the inner edges of the half-shelf pair 48 could be safety edges 100 or pressure sensitive devices. The inner edges 54 could comprise compressible, resilient material that may include rubber, flexible polyurethane foam, plastic or other similar material. In this manner, if a portion of the operator's body (e.g., hand or the like) or could be caught within a closing gap 82, as formed between the inner edges 54, as the gap 82 is generally closing during cart operations, the inner edges 54 then could deform around the portion of the operator's hand to substantially prevent the half-shelf pair 48 from pinching or crushing the portion of the operator's hand (not shown).

At the substantial competition of this step, the process 200 could proceed to step 206, moving the folding tray cart into complete opening/operating position.

In step 206, moving the folding tray cart into complete open/operating position, the compressed resilient washer-based resistance may make the operator more aware to generally moving the operator's hands away from the closing gap or may use the operator's hands instead to push down on the tops (e.g., handles) of the inner vertical struts (e.g., of the inner framework section) or the non-gap surfaces of the respective split-shelf to substantially complete the moving of the folding tray cart into open operative position. As the operator continues to move the cart to substantially complete the open horizontal operational position, crushing and pinch injuries may be avoided.

Alternatively, in other version of the invention wherein the inner edges of the half-selves pairs may be safety edges, the safety edges could deform around the portion(s) of the operator's body that may be caught in the closing gap formed by the moving top split-shelf. This deformation of the compressible safety edges may absorb the destructive pressure that may be created by the moving half-shelve pair that could otherwise damage a portion of the operator's body that may be caught by the closing gap.

The process 100 may be repeated by returning to step 202, placing folding tray cart into the collapsed storage state.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A folding tray cart comprising:
a collapsible framework pivotally supporting one or more sets of split shelves, each split shelf comprises a pair of half shelves, the folding tray cart moves between an first open operating position with the respective sets of split shelves being held in spaced-apart, stacked, horizontal orientation within the collapsible framework and a second closed, vertical orientation where the collapsible framework is collapsed in manner that places each half shelf pair into an inverted “V” configuration;
wherein inner edges of the half shelf pairs are made from soft, resilient, compressible material so that if a portion of a cart operator's body is caught between a closing gap formed between the inner edges, the inner edges will temporarily deform in a manner to prevent injury to said portion.

2. The folding tray cart of claim 1 wherein any portion of the cart operator's body is a hand of the operator.

3. The folding tray cart of claim 1 wherein the inner edge is a safety strip with a lateral cross section shape of a right triangle that defines the sides of the safety strip being the opposite side, adjacent side, and hypotenuse side.

4. The folding tray cart of claim 3 wherein the opposite side attaches the safety strip to the respective half shelf while the adjacent side is continuous with the top of the respective half shelf.

5. The folding tray cart of claim 3 wherein the opposite side further comprises a double-sided adhesive strip that attaches the safety strip to the respective half shelf.

6. The folding tray cart of claim 3 wherein the hypotenuse side denotes an angled underside of the safety strip.

7. The folding tray cart of claim 3 wherein the first open operating position locates the respective safety strips' outward edges adjacent to one another.

8. The folding tray cart of claim 1 wherein the soft, resilient, compressible material could be a polymer selected from a group of polymers that consists of rubber, flexible polyurethane foam, plastic.

9. A folding tray cart comprising:
a collapsible framework pivotally supporting one or more sets of split shelves that are movably attached to the collapsible framework, each split shelf further comprises a pair of half shelves, the folding tray cart moves between a first, compacted, storage position to a second, open, operative position;
wherein the first, compacted, storage position compacts the collapsible framework to place each half shelf pair into an inverted “V”-shaped configuration;
wherein the second, open, operative position places the set of split shelves into a spaced-apart, stacked, horizontal orientation within the collapsible framework;
wherein each side of the respective half shelf by the half shelf's inner edge is movably connected to a respective inner vertical spar, each inner vertical spar further comprising a vertically oriented spring that is biased to slow down the movement of respective inner vertical spar and connected split shelves as the folding tray cart moves from the first, compacted, storage position to the second, open, operative position.

10. The folding tray cart of claim 9 wherein the vertically oriented spring is a compression cylindrical coil spring.

11. The folding tray cart of claim 10 wherein the inner vertical spar passes through and movably holds captive the respective vertically oriented spring.

12. The folding tray cart of claim 11 wherein the inner vertical spar's top supports a handle while the vertically oriented spring's bottom movably passes through a slider, the lockable handle further compresses the vertically oriented spring against the slider as the folding tray cart completes the movement from the first, compacted, storage position to the second, open, operative position.

13. The folding tray cart of claim 12 wherein the handle is removably lockable to the collapsible framework when the collapsible framework is in the second, open, operative position.

14. A folding tray cart comprising:
a collapsible framework that moveably supports a set of split-shelving with at least one fastener combination that pivotally connects at least one split-shelving from the set of split-shelving to the collapsible framework, the at least one fastener combination movably compresses the collapsible framework and a split-shelving together,
wherein the compression imposed by the fastener combination imparts a frictional force to the split shelving and collapsible framework to slow the movement of the folding tray cart between a first, compacted, storage position to the second, open, operative position.

15. The folding tray cart of claim 14 wherein the fastener combination further includes a washer that is made from a noncompressible material.

16. A folding tray cart of claim 14 wherein fastener combination further includes a washer that is made from a compressible material.

17. A folding tray cart of claim 15 wherein the washer is sandwiched between the collapsible framework and the split shelf.

18. A folding tray cart of claim 15 wherein the washer is sandwiched between the fastener and the collapsible framework.

19. A folding tray cart of claim 14 wherein the collapsible framework and split shelves have rough surfaces where the collapsible framework and split shelves pivotally contact each other through the application of the fastener combinations, the interaction of rough surfaces further imparts addition friction forces to further slow the movement of the folding tray cart from a first, compacted, storage position to the second, open, operative position.

20. A folding tray cart of claim 14 wherein the fastener combination uses a fastener from a group of fasteners consisting of screw and nut combination, screw and double nut combination, a bolt and nut combination, bolt and double nut combination, rivet.
